(19) United States
(12) Patent Application Publication
(10) Pub. No.: US 2022/0119296 A1
(43) Pub. Date: Apr. 21, 2022

(54) Blow Head

(71) Applicant: Toyo Glass Co., Ltd., Tokyo (JP)

(72) Inventors: Tasho SHIMADA, Tokyo (JP); Yuuichi OHYA, Tokyo (JP); Yukio SATOH, Tokyo (JP); Hideo HIRANO, Tokyo (JP); Akira KOBAYASHI, Tokyo (JP)

(21) Appl. No.: 17/281,635

(22) PCT Filed: Sep. 16, 2020
(86) PCT No.: PCT/JP2020/035021

§ 371 Date: Mar. 31, 2021

(30) Foreign Application Priority Data
Feb. 26, 2020 (JP) 2020-030405

(51) Int. Cl. C03B 9/36

(52) U.S. Cl. CPC C03B 9/36

(57) ABSTRACT

To prevent the tilting of the glass bottle when the finish mold is separated, the blow head (20) for blow molding a glass bottle (C) that is positioned above a finish mold (14) having a pair of mold parts separated by a parting surface (14A) extending vertically and interposing a bottom mold (12) between the two parts, the blow head being configured to blow air into a mouth (P1) of a parison (P) that protrudes upward from the finish mold, the blow head, comprises a head main body (21) including a skirt portion (22) that is positioned in a lower part thereof and opens downward, the skirt portion defining a chamber (26) for receiving the mouth in cooperation with an upper surface of the finish mold, a nozzle (42) positioned inside the skirt portion, and configured to blow compressed air into the mouth, an abutting member (45) vertically movably supported inside the skirt portion, and configured to selectively abut against the upper end surface of the mouth, and a biasing member (51) interposed between the skirt portion and the abutting member to bias the abutting member downward.

### TECHNICAL FIELD

The present invention relates to a blow head for blow molding a glass bottle that is positioned above a finish mold having a parting surface extending vertically to blow air into the mouth of a parison that protrudes upward from the finish mold.

### BACKGROUND ART

The blow molding method is known as a method for molding glass bottles. As described in Patent Document 1, when molding a glass bottle from a parison by using the blow molding method, a finish mold, a bottom mold, and a blow head for blowing compressed air into a parison are employed. The finish mold has a parting surface that extends vertically, and cooperates with the bottom mold to form the outer shape of the bottle. The parison is supported by the finish mold so that the mouth of the parison protrudes upward from the finish mold. The blow head is placed at an upper end of the finish mold so as to cover the mouth of the parison. A glass bottle is formed by supplying compressed air from the blow head to the mouth of the parison so that the parison expands to conform to the shape of the finish mold.

### PRIOR ART DOCUMENT(S)

### Patent Document(s)

Patent Document 1: JPH8-91854A

### SUMMARY OF THE INVENTION

### Task to be Accomplished by the Invention

Once the glass bottle is molded, the two parts of the finish mold are separated from each other sideways so that the glass bottle can be removed from the finish mold. At this time, the frictional force generated between the finish mold and the glass bottle may pull the glass bottle toward the finish mold and tilt the glass bottle on the bottom mold. When the glass bottle is tilted, the glass bottle may interfere with the finish mold and the bottom mold with the result that an undesired flaw may be created in the glass bottle. To prevent the tilting of the glass bottle when the finish mold is separated, it is conceivable to press the mouth of the glass bottle against the bottom mold with the blow head. However, it is difficult to eliminate a gap between the glass bottle and the blow head since the glass bottle has a dimensional error and shrinks as the temperature of the glass bottle drops. Therefore, it is difficult to prevent the tilting of the glass bottle.

In view of such a problem of the prior art, a primary object of the present invention is to provide a blow head that can prevent the tilting of the glass bottle when the finish mold is separated.

To achieve such an object, the present invention provides a blow head (20) for blow molding a glass bottle (C) that is positioned above a finish mold (14) having a pair of mold parts separated by a parting surface (14A) extending vertically and interposing a bottom mold (12) between the two parts, the blow head being configured to blow air into a mouth (P1) of a parison (P) that protrudes upward from the finish mold, the blow head, comprising:

a head main body (21) including a skirt portion (22) that is positioned in a lower part thereof and opens downward, the skirt portion defining a chamber (26) for receiving the mouth in cooperation with an upper surface of the finish mold;

a nozzle (42) positioned inside the skirt portion, and configured to blow compressed air into the mouth;

an abutting member (45) vertically movably supported inside the skirt portion, and configured to selectively abut against the upper end surface of the mouth; and

a biasing member (51) interposed between the skirt portion and the abutting member to bias the abutting member downward.

Since the abutting member which is urged downward by the biasing member presses the mouth of the glass bottle downward, the tilting of the glass bottle when opening the finish mold can be prevented. By preventing the tilting of the glass bottle, the interference between the glass bottle and the finish mold can be avoided, and the occurrence of flaws in the glass bottle can be avoided.

Preferably, the biasing member includes a spring member interposed between an upper surface of the abutting member and an inner surface of the skirt portion.

Thereby, the structure of the biasing member can be simplified and minimized in size.

Preferably, the abutting member is formed in a disk shape having vertically facing surfaces, and centrally provided with a through hole (46) through which the nozzle (42) extends.

Thereby, the abutting member can be arranged so as not to interfere with the nozzle.

Preferably, the abutting member is provided with a groove (45E) extending radially outward from the through hole on a lower surface thereof, the abutting member separating the chamber into an upper chamber (26A) and a lower chamber (26A), and the skirt portion is provided with a passage (57, 58) communicating the upper chamber with the lower chamber.

Thus, the compressed air supplied from the nozzle creates a difference in the pressure applied to the upper surface and the lower surface, but the passage reduces this pressure difference. As a result, the biasing force required for the biasing member can be reduced. Further, since the compressed air is supplied to the lower chamber, the outer periphery of the mouth of the glass bottle can be favorably cooled by the compressed air.

Preferably, a snap ring (49) is detachably attached to an inner surface of the skirt portion, the snap ring being configured to abut against an outer peripheral portion of the lower surface of the abutting member to restrict a downward movement of the abutting member.

Thus, the abutting member can be removed from the skirt portion by removing the snap ring so that the maintenance of the abutting member can be facilitated.

Preferably, the abutting member includes a plate member (45A) made of carbon and a washer (45C) provided on an outer peripheral portion of a lower surface of the plate member, the abutting member being configured to abut against the snap ring via the washer.

Thus, the abutting member can abut against the mouth via the plate member made of carbon. Since carbon is relatively resistant to thermal shock, the plate member is not likely to be damaged by the cyclic heat received from the mouth. Further, by providing the washer, the direct contact between the plate member made of carbon and the snap ring can be avoided so that flaking or spalling damage to the plate member can be prevented.

Preferably, the head main body is provided with an air passage (32) for supplying compressed air to the nozzle, and an air filter (53) placed in the air passage.

Thereby, foreign matter that may be contained in the compressed air can be removed at a position close to the parison so that the removal of the foreign matter can be performed in a reliable manner.

### Effect of the Invention

The present invention thus provides a blow head that can prevent the tilting of the glass bottle when the finish mold is separated.

### BRIEF DESCRIPTION OF THE DRAWING(S)

FIG. 1 is a side view of a molding apparatus;

FIG. 2 is a sectional view showing a finish mold, a bottom mold and a blow head;

FIG. 3 is a sectional view of the blow head;

FIG. 4 is a plan view of the blow head with an air filter thereof omitted from illustration;

FIG. 5 is a bottom view of an abutting member; and

FIG. 6 is a diagram illustrating the state of the blow head, the glass bottle, and the bottom mold when the finish mold has moved to a retracted position.

### DESCRIPTION OF THE PREFERRED EMBODIMENT(S)

An embodiment of the present invention is described in the following. A blow head is a device that blows compressed air into a parison in blow molding a glass bottle from the parison. The blow head forms a part of a glass container molding apparatus.

The molding apparatus is configured to execute a step of molding a parison from a glass gob and a step of molding a glass container from the parison.

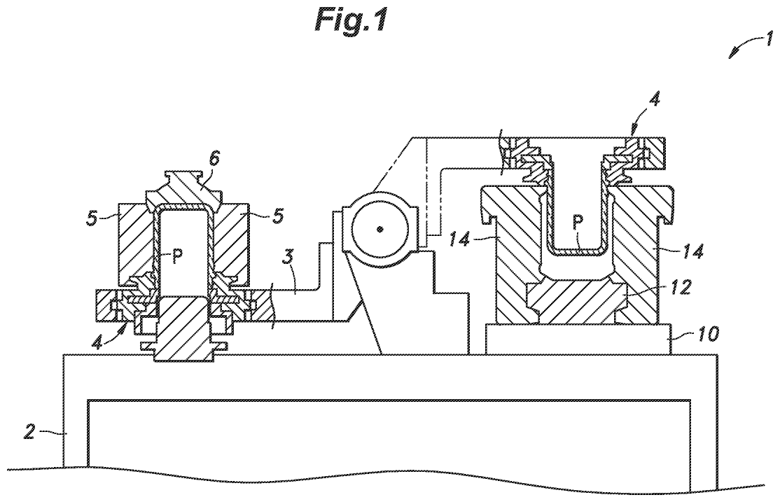

As shown in FIG. 1, the molding apparatus 1 is provided with an arm 3 rotatably supported by a base 2. The arm 3 has a rotational center extending in the horizontal direction, and rotates between an initial position and an inverted position rotated by 180° with respect to the initial position. At least one mouth mold 4 is supported by the free end of the arm 3. The mouth mold 4 includes a pair of mold parts having a vertically extending parting surface, and a guide ring positioned between the mold parts. The mold parts and the guide ring are supported by the arm 3. The base 2 is provided with a plunger that passes through the guide ring and projects into the cavity defined between the mold parts when the mouth mold 4 is in the initial position.

A blank mold 5 is positioned above the mouth mold 4. The blank mold 5 includes a pair of mold parts having a vertically extending parting surface, and are positioned so as to interpose the mouth mold 4 from either side at the lower end portions thereof. The blank mold 5 form a shape corresponding to the side portion P2 of the parison P at the parting surface. The upper end opening of the blank mold 5 is closed by a baffle 6 in a selective manner.

The process of molding a parison P from a glass gob can be performed by, for example, blow molding. Initially, the gob is charged into the mouth mold 4 and the blank mold 5 while the baffle 6 is retracted. Then, the upper end of the blank mold 5 is closed by the baffle 6, and compressed air which may be called as “settle blow” is injected via the baffle 6 to press the gob against the mouth mold 4 to form the mouth P1 of the parison P. At this time, a male screw P4 and a bead P5 are formed on the outer circumferential surface of the mouth P1. The bead P5 is a protrusion that protrudes outward in the radial direction with respect to the outer circumferential surface of the mouth P1, and extends in the circumferential direction to form an annular shape.

Thereafter, compressed air is injected into the mouth P1 from between the mouth mold 4 and the plunger. As a result, the gob expands and is pressed against the blank mold 5 and the baffle 6 to form the side portion P2 and the bottom portion P3 of the parison P, and the parison P is formed. Next, the baffle 6 and the plunger are retracted, and the two parts of the blank mold 5 are separated from each other to expose the parison P. In this state, the parison P is supported by the mouth mold 4 at the mouth P1. Then, the arm 3 is moved to the inverted position to invert the parison P so that the mouth P1 is positioned at the upper end, and is suspended from the mouth mold 4. Alternatively, press molding or narrow neck press molding may be employed to mold the parison P, instead of blow molding.

On the base 2 is provided a distributor plate 10 is positioned under the mouth mold 4 in the inverted position. A bottom mold 12 for forming the bottom portion of the glass container C is positioned on the upper surface of the distributor plate 10. The relative position of the distributor plate 10 and the bottom mold 12 is determined by a pair of engaging portions that fit into each other.

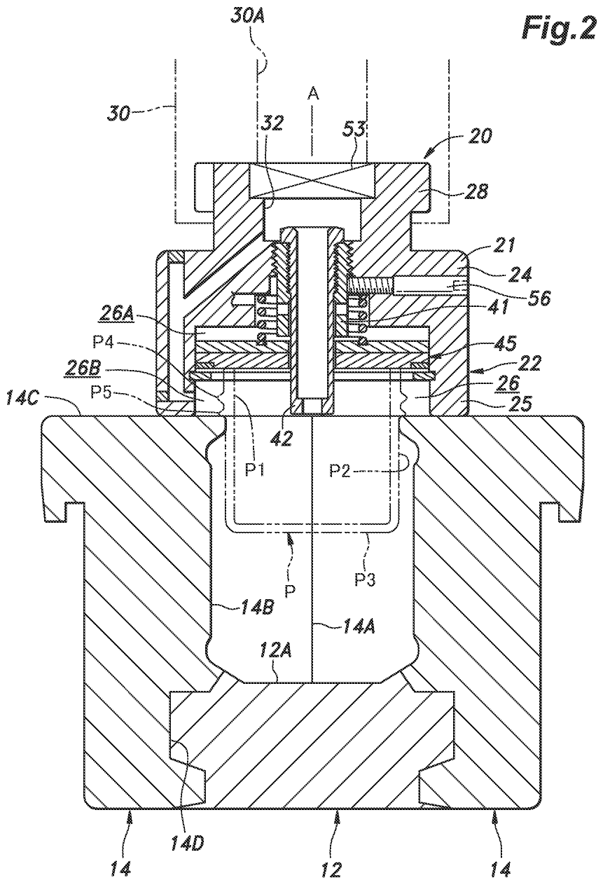

As shown in FIG. 2, the upper surface of the bottom mold 12 forms a bottom mold surface 12A having a shape corresponding to the bottom surface of the glass container C to be molded.

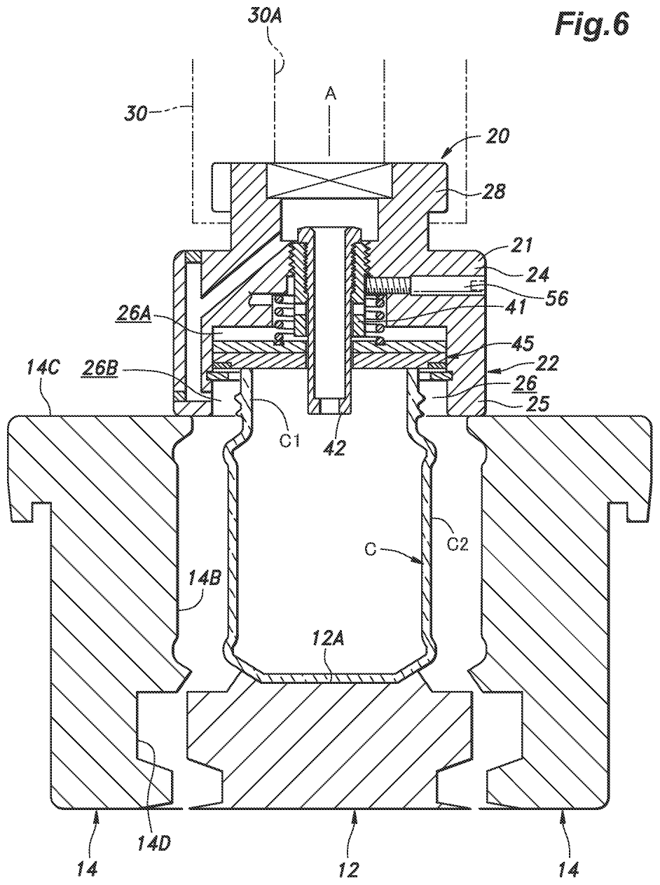

A finish mold 14 including a pair of mold parts is positioned above the bottom mold 12. The finish mold 14 defines a vertically extending parting surface 14A at which the two mold parts thereof abut against each other, and a side mold surface 14B formed in the parting surface 14A. The side mold surface 14B has a shape corresponding to the surface of the side portion C2 of the glass container C to be molded (see FIG. 6). The side mold surface 14B extends to the upper end surfaces 14C of the two mold parts of the finish mold 14. The upper end surfaces 14C jointly define a single plane. The lower part of the finish mold 14 is provided with a clamping portion 14D that is configured to retain the bottom mold 12 from either side.

The finish mold 14 is supported by a support device (not shown in the drawings), and is moveable between a molding position where the two mold parts are joined to each other at the parting surface 14A, and a retracted position where the two mold parts are separated from each other, and from the bottom mold 12. When the finish mold 14 is in the molding position, the bottom mold 12 is clamped in the clamping portion 14D of the finish mold 14. As a result, the relative position of the two parts of the finish mold 14 and the bottom mold 12 is determined. At this time, the bottom mold 12 and the finish mold 14 are positioned along an axis A extending vertically. When the finish mold 14 is in the molding position, the bottom mold surface 12A and the side mold surface 14B are smoothly connected to each other to form a shape corresponding to the outer surface (outer shape) of the glass container C to be molded.

The bottom mold 12 and the finish mold 14 form a container molding die assembly for molding the glass container C. The side mold surface 14B and the bottom mold surface 12A are employed to form the surface of the glass container C. The bottom mold 12 and the finish mold 14 are made of a metal such as cast iron.

By moving the arm 3 to the inverted position while the finish mold 14 is in the retracted position, the parison P suspended from the mouth mold 4 is positioned above the bottom mold 12. At this time, the two parts of finish mold 14 are separated from each other in opposite directions from the axis A. By moving the finish mold 14 in this state from the retracted position to the molding position, the parison P is positioned between the corresponding parts of the mold surfaces 14B of the two mold parts of the finish mold 14. At this time, the mouth P1 of the parison P protrudes upward from the upper end surface 14C of the finish mold 14. When the mold parts of the mouth mold 4 are separated from each other, the mouth mold 4 releases the parison P with the result that the parison P is supported by the finish mold 14. At this time, the bead P5 of the parison P is engaged by the upper end surface 14C of the finish mold 14 so that the downward movement of the parison P with respect to the finish mold 14 is restricted. After the mouth mold 4 has released the parison P, the arm 3 moves to the initial position so that the mouth mold 4 is released from the upper end of the finish mold 14.

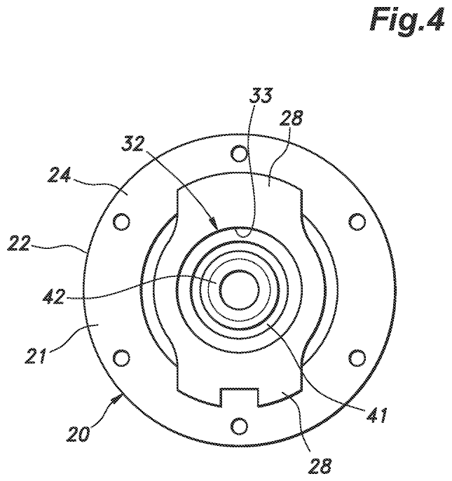

As shown in FIGS. 2 to 4, the blow head 20 includes a head main body 21. The head main body 21 includes a skirt portion 22 opening downward in a lower part thereof. The skirt portion 22 has a disk-shaped base portion 24 and a cylindrical side wall portion 25 extending downward from the base portion 24. The base portion 24 is formed in a disk shape having a certain vertical thickness. The base portion 24 and the side wall portion 25 are positioned around the central axis A. The base portion 24 and the side wall portion 25 jointly define a chamber 26 that opens downward.

A locking protrusion 28 projects upward from an upper part of the base portion 24. The locking protrusion 28A is configured to be engaged by a blow head support device 30 that moves the blow head 20. The base portion 24 is provided with a central hole 32 extending vertically along the central axis A. The central hole 32 is passed vertically through the base portion 24 and the locking protrusion 28.

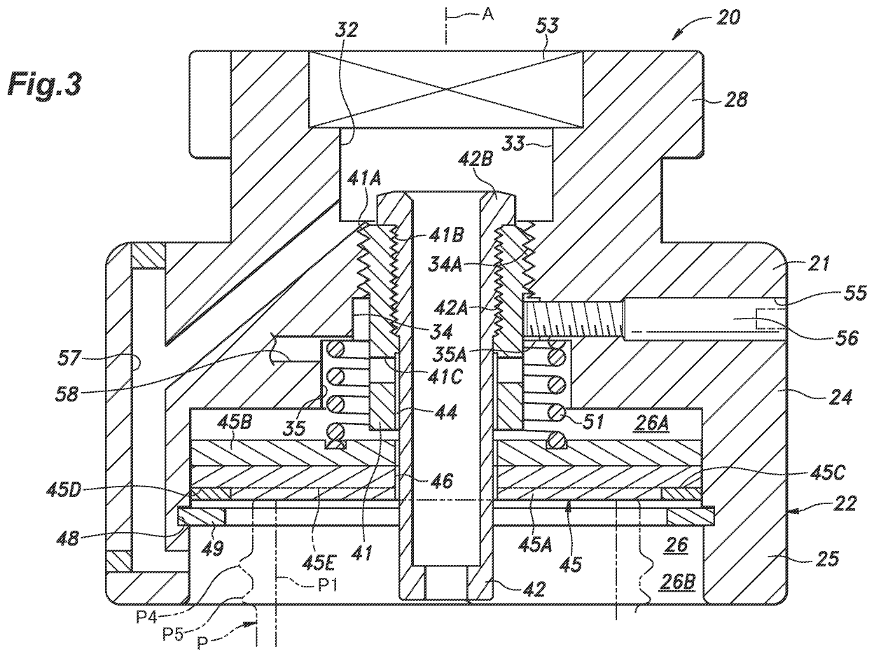

As shown in FIG. 3, the central hole 32 includes a first hole portion 33, a second hole portion 34, and a third hole portion 35 in this order from the upper end. The first to third hole portions 33 to 35 are each circular in cross section and each have a constant diameter, and are positioned coaxially with each other. The diameter of the second hole portion 34 is smaller than the diameters of the first hole portion 33 and the third hole portion 35. Alternatively, the third hole portion 35 may be omitted and the second hole portion 34 may form the lower end of the central hole 32. Further, each of the first to third hole portions 33 to 35 may be composed of a plurality of sections having different diameters.

A female screw 34A is formed on the inner circumferential surface of the second hole portion 34. A cylindrical sleeve 41 extending vertically and having two open ends is received in the second hole portion 34 and the third hole portion 35. An upper end of the outer circumferential surface of the sleeve 41 is provided with a male screw 41A which is threaded into the female screw 34A of the second hole portion 34. The outer diameter of the sleeve 41 is smaller than the inner diameter of the third hole portion 35 so that a gap is created between the outer circumferential surface of the sleeve 41 and the inner circumferential surface of the third hole portion 35. The lower end of the sleeve 41 protrudes from the lower end of the central hole 32, and is positioned in the chamber 26.

A vertically extending nozzle 42 is received in the sleeve 41. The nozzle 42 is formed in a cylindrical shape with two open ends. A male screw 42A is formed on an upper end part of the outer circumferential surface of the nozzle 42, and a female screw 41B is formed on an upper end part of the inner circumferential surface of the sleeve 41. By threading the male screw 42A of the nozzle 42 into the female screw 41B of the sleeve 41, the nozzle 42 is supported inside the sleeve 41. Further, the upper end of the nozzle 42 is provided with a flange 42B protruding radially outward. By abutting the flange 42B against the upper end surface of the sleeve 41, the position of the nozzle 42 with respect to the sleeve 41 is determined. The lower end of the nozzle 42 extends beyond the lower end of the sleeve 41, and is positioned inside the skirt portion 22, or in other words, inside the chamber 26.

A gap 44 is defined between the inner circumferential surface of the lower end part of the sleeve 41 and the outer circumferential surface of the nozzle 42. The inner diameter of the lower end part of the sleeve 41 may be made larger than the inner diameter of the remaining part of the sleeve 41 in order to form the gap 44. The gap 44 is formed in a cylindrical shape along the inner circumferential surface of the sleeve 41. A plurality of communication holes 41C penetrating in the radial direction are formed in a lower end part of the sleeve 41. The communication holes 41C communicate the gap 44 with the exterior of the sleeve 41.

Alternatively, the sleeve 41 may be integrally formed with the nozzle 42. More specifically, the sleeve 41 may be omitted so that the nozzle 42 is threaded directly into the second hole portion 34.

The blow head 20 includes an abutting member 45 supported so as to be vertically movable inside the skirt portion 22, or in other words inside the chamber 26. The abutting member 45 is formed as a disk facing vertically. The outer circumferential surface of the abutting member 45 is in sliding contact with the inner circumferential surface of the skirt portion 22. The abutting member 45 divides the chamber 26 defined in the skirt portion 22 into an upper chamber 26A and a lower chamber 26B. A nozzle receiving hole 46 formed as a through hole that centrally and vertically penetrates the abutting member 45. The nozzle 42 passes through the nozzle receiving hole 46 and extends above and below the abutting member 45. The inner diameter of the nozzle receiving hole 46 is larger than the outer diameter of the nozzle 42 so that a gap is created between the nozzle 42 and the nozzle receiving hole 46.

The abutting member 45 includes a disk-shaped main plate 45A facing vertically, and a plate-shaped liner plate 45B attached to the upper surface of the main plate 45A. The main plate 45A is preferably made of a material that is resistant to thermal shock. For example, the main plate 45A may be made of a material having high thermal conductivity. In this embodiment, the main plate 45A is made of carbon. Further, the main plate 45A preferably has a structure resistant to thermal shock. In another embodiment, the main plate 45A is made of metal and has a knurled lower surface.

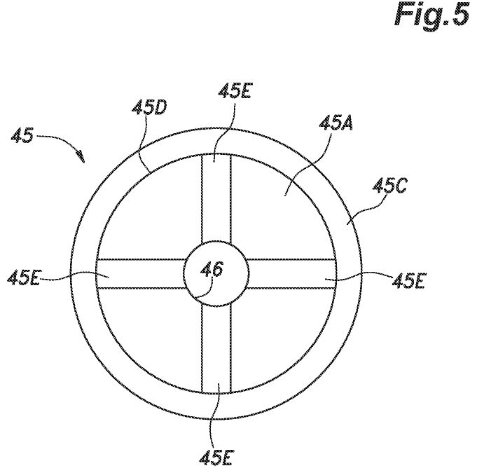

As shown in FIGS. 3 and 5, in the present embodiment, the abutting member 45 is provided with a washer 45C on an outer peripheral part of the lower surface of the main plate 45A. The washer 45C may be made of, for example, metal. The washer 45C is formed in an annular shape along the outer periphery of the main plate 45A. Preferably, and a receiving groove 45D for receiving the washer 45C is formed on the outer peripheral part of the lower surface of the main plate 45A.

As shown in FIG. 3, an annular ring groove 48 extending in the circumferential direction is formed on the inner circumferential surface of the side wall portion 25 forming the skirt portion 22. A snap ring 49 is detachably retained in the ring groove 48. The snap ring 49 is formed in a C shape so as to be elastically deformable in a radially inward direction. The outer peripheral portion of the snap ring 49 is received in the ring groove 48, and the inner peripheral portion of the snap ring 49 protrudes radially inward with respect to the inner circumferential surface of the side wall portion 25. When the lower surface of the outer peripheral portion of the abutting member 45 abuts against the upper surface of the inner peripheral portion of the snap ring 49, the downward movement of the abutting member 45 is restricted. The abutting member 45 can move vertically between a lower limit position defined by the contact of the lower surface of the abutting member 45 with the snap ring 49, and an upper limit position defined by the contact of the upper surface of the abutting member 45 with the lower end of the sleeve 41. The vertical stroke of the abutting member 45 is preferably 1 mm or more and 10 mm or less.

As shown in FIGS. 3 and 5, the abutting member 45 has at least one groove 45E extending radially outward from the nozzle receiving hole 46 on the lower surface thereof. The grooves 45E may be arranged at intervals of 90° about the central axis A, for example. Further, in another embodiment, the abutting member 45 is formed with a plurality of communication holes (not shown) penetrating vertically.

As shown in FIG. 3, a biasing member 51 for urging the abutting member 45 downward with respect to the skirt portion 22 is provided between the skirt portion 22 and the abutting member 45. The biasing member 51 may be a spring member interposed between the upper surface of the abutting member 45 and the inner surface of the skirt portion 22. In this embodiment, the biasing member 51 is a compression coil spring. The biasing member 51 is preferably a compression coil spring made of a heat-resistant alloy. The biasing member 51, in this case, consisting of a compression coil spring, is positioned around of the sleeve 41, and extends along the axis A. The upper end of the biasing member 51 abuts against a downwardly facing shoulder surface 35A defined at the boundary between the second hole portion 34 and the third hole portion 35, and the lower end of the biasing member 51 abuts against the upper surface of the abutting member 45.

An air filter 53 is fitted in the upper end of the first hole portion 33 of the central hole 32. The air filter 53 is formed of a mesh or a porous member through which air can pass, and removes foreign matter from the passing air. In the present embodiment, the upper end portion of the first hole portion 33 has a larger diameter than the lower end portion thereof, and the air filter 53 is fitted in the upper end portion of the first hole portion 33.

The upper end of the blow head 20 is connected to the blow head support device 30, and the upper end of the first hole portion 33 communicates with a compressed air supply passage 30A formed in the blow head support device 30. The compressed air supply passage 30A is connected to a compressed air supply source such as a compressor via a control valve.

The base portion 24 of the skirt portion 22 is provided with a screw hole 55 extending in the radial direction from the outer circumferential surface of the skirt portion 22 to the inner circumferential surface of the second hole portion 34. A stop screw 56 is inserted into the screw hole 55. The tip of the stop screw 56 projects into the second hole portion 34 and is in contact with the outer circumferential surface of the sleeve 41. As a result, the rotation of the sleeve 41 with respect to the head main body 21 is prevented.

As shown in FIG. 3, a first air passage 57 is formed in the base portion 24 and the side wall portion 25 of the skirt portion 22 to communicate the first hole portion 33 with the lower chamber 26B. The first air passage 57 opens at a part of the inner circumferential surface of the side wall portion 25 located below the ring groove 48. Further, the base portion 24 and the side wall portion 25 of the skirt portion 22 are provided with a second air passage 58 communicating the upper chamber 26A with the first hole portion 33. In the present embodiment, the second air passage 58 communicates with the upper chamber 26A via the third hole portion 35.

The blow head support device 30 is configured to move the blow head 20 between a retracted position and a work position. When the blow head 20 is in the retracted position, the parison P can be charged into the finish mold 14 and the bottom mold 12, and the mold glass bottle can be removed from the finish mold 14 and the bottom mold 12.

When the parison P is charged into the finish mold 14 and the bottom mold 12, the blow head 20 moves to the work position. The blow head 20 is positioned on the axis A and on the upper end surface 14C of the finish mold 14 at the work position. more specifically, the lower end surface of the side wall portion 25 of the skirt portion 22 comes into contact with the upper end surface 14C of the finish mold 14, and the skirt portion 22 covers the mouth P1 of the parison P. Further, the upper end surface of the mouth P1 of the parison P, which is the open end surface, abuts against the lower surface of the abutting member 45 with the result that the abutting member 45 is pushed upward against the urging force of the biasing member 51. At this time, the parison P is supported by the upper end surface 14C of the finish mold 14 at the bead P5, and is pushed downward by the abutting member 45 at the upper end surface of the mouth P1. In other words, the parison P is vertically interposed between the finish mold 14 and the abutting member 45.

When the blow head 20 is at the work position, compressed air is supplied from a compressed air supply source to the first hole portion 33 of the blow head 20 via the compressed air supply passage 30A. The compressed air passes through the air filter 53 in the first hole portion 33, and foreign matter is removed from the compressed air. After that, the compressed air passes through the nozzle 42 and is supplied to the inside of the mouth P1 of the parison P. As a result, the parison P expands toward the side mold surface 14B of the finish mold 14 and the bottom mold surface 12A of the bottom mold 12, and is formed into a glass bottle C. At this time, a part of the compressed air supplied to the first hole portion 33 passes through the first air passage 57 and is supplied to the lower chamber 26B. A part of the compressed air supplied to the lower chamber 26B passes through a small gap created in the contact portion between the lower end surface of the side wall portion 25 of the skirt portion 22 and the upper end surface 14C of the finish mold 14 to be expelled out of the skirt portion 22. Further, a part of the compressed air supplied into the glass bottle C passes through the groove 45E on the lower surface of the abutting member 45 and flows into the lower chamber 26B. Further, a part of the compressed air supplied into the glass bottle C passes through the gap between the nozzle receiving hole 46 and the nozzle 42, and passes between the lower end surface of the sleeve 41 and the upper surface of the abutting member 45 before flowing into the upper chamber 26A. When the lower end surface of the sleeve 41 and the upper surface of the abutting member 45 are in contact with each other, the compressed air flowing through the gap between the nozzle receiving hole 46 and the nozzle 42 passes through the gap 44 and the communication hole 41C, and flows into the upper chamber 26A. As a result, the pressures in the upper chamber 26A and the lower chamber 26B are substantially equalized even during the time when the compressed air is supplied to the blow head 20. Further, the pressure in the glass bottle C and the pressure in the upper chamber 26A become substantially equal to each other. As a result, the upward force received by the abutting member 45 from the compressed air can be minimized. As a result, the urging force to be generated by the biasing member 51 can be reduced. Further, by supplying compressed air to the lower chamber 26B, the outer peripheral portion of the mouth C1 of the glass bottle C is cooled.

After the glass bottle C is molded, the finish mold 14 is moved to the retracted position while the blow head 20 is maintained at the work position. At this time, the abutting member 45 which is urged downward by the biasing member 51 pushes the upper end surface of the mouth C1 of the glass bottle C downward. As a result, as shown in FIG. 6, the glass bottle C is interposed between the bottom mold 12 and the abutting member 45. Therefore, the glass bottle C can maintain an upright posture without tilting even if a lateral force due to a frictional force generated between the glass bottle C and the finish mold 14 is applied to the glass bottle C. As a result, interference between the glass bottle C and the finish mold 14 or the bottom mold 12 can be avoided, and the occurrence of defects or flaws in the glass bottle C can be prevented.

The abutting member 45 is supported by the skirt portion 22 via the snap ring 49. Since the snap ring 49 is detachable, maintenance work such as replacing the abutting member 45 is facilitated. Further, by using the snap ring 49, the support structure of the abutting member 45 can be simplified.

The abutting member 45 comes into contact with the mouths P1 and C1 of the parison P and the glass bottle C at the main plate 45A made of carbon. Since carbon has a relatively high resistance to thermal shock, the main plate 45A is less likely to be damaged by the cyclic heat transmitted from the mouths P1 and C1. Further, by providing the washer 45C, contact between the main plate 45A and the snap ring 49 can be avoided so that the flaking of the main plate 45A can be prevented.

The blow head 20 can prevent the upward movement of the mouth C1 during the molding of the glass bottle C so that variations in the vertical dimension of the molded glass bottle C and tilting of the mouth C1 can be prevented.

Since the air filter 53 is provided in the head main body 21, the distance between the air filter 53 and the parison P (glass bottle C) can be minimized. As a result, foreign matter is less likely to be mixed into the compressed air after passing through the air filter 53 so that the parison P (glass bottle C) is prevented from being exposed to foreign matter in a highly reliable manner.

The present invention has been described in terms of a specific embodiment, but is not limited by such an embodiment, and can be modified in various ways without departing from the scope of the present invention. For instance, the biasing member 51 may be a different kind of spring such as a leaf spring. Further, instead of the biasing member 51 in such a form as a spring, an air cylinder may be employed to urge the abutting member 45 downward. Further, a pressure chamber may be formed on the upper side of the abutting member 45 so that the abutting member 45 may be urged downward by supplying compressed air to the pressure chamber.

| | |
|---|---|
| 1: molding apparatus | 12: bottom mold |
| 14: finish mold | 14a: parting surface |
| 14c: upper end surface | 20: blow head |
| 21: head main body | 22: skirt portion |
| 24: base portion | 25: side wall portion |
| 26: chamber | 26A: upper chamber |
| 26B: lower chamber | 41: sleeve |
| 42: nozzle | 45: abutting member |
| 45A: main plate | 45B: liner plate |
| 45C: washer | 45E: groove |
| 46: nozzle receiving hole | 48: ring groove |
| 49: snap ring | 51: biasing member |
| 53: air filter | 57: first air passage |
| 58: second air passage | A: axis |
| C: glass container | P: parison |
| P1, C1: mouth | |

1. A blow head for blow molding a glass bottle that is positioned above a finish mold having a pair of mold parts separated by a parting surface extending vertically and interposing a bottom mold between the two parts, the blow head being configured to blow air into a mouth of a parison that protrudes upward from the finish mold, the blow head, comprising:
a head main body including a skirt portion that is positioned in a lower part thereof and opens downward, the skirt portion defining a chamber for receiving the mouth in cooperation with an upper surface of the finish mold;
a nozzle positioned inside the skirt portion, and configured to blow compressed air into the mouth;
an abutting member vertically movably supported inside the skirt portion, and configured to selectively abut against the upper end surface of the mouth; and
a biasing member interposed between the skirt portion and the abutting member to bias the abutting member downward.

2. The blow head according to claim 1, wherein the biasing member includes a spring member interposed between an upper surface of the abutting member and an inner surface of the skirt portion.

3. The blow head according to claim 1, wherein the abutting member is formed in a disk shape having vertically facing surfaces, and centrally provided with a through hole through which the nozzle extends.

4. The blow head according to claim 3, wherein the abutting member is provided with a groove extending radially outward from the through hole on a lower surface thereof, the abutting member separating the chamber into an upper chamber and a lower chamber, and the skirt portion is provided with a passage communicating the upper chamber with the lower chamber.

5. The blow head according to claim 3, wherein a snap ring is detachably attached to an inner surface of the skirt portion, the snap ring being configured to abut against an outer peripheral portion of the lower surface of the abutting member to restrict a downward movement of the abutting member.

6. The blow head according to claim 5, wherein the abutting member includes a plate member made of carbon and a washer provided on an outer peripheral portion of a lower surface of the plate member, the abutting member being configured to abut against the snap ring via the washer.

7. The blow head according to claim 1, wherein the head main body is provided with an air passage for supplying compressed air to the nozzle, and an air filter placed in the air passage.
